(19) United States
(12) Patent Application Publication
(10) Pub. No.: US 2020/0120962 A1
(43) Pub. Date: Apr. 23, 2020

(54) Tasty P

(71) Applicant: ENA MAY WATSON, Clinton, MD (US)

(72) Inventor: ENA MAY WATSON, Clinton, MD (US)

(21) Appl. No.: 16/659,572

(22) Filed: Oct. 22, 2019

Related U.S. Application Data
(60) Provisional application No. 62/747,748, filed on Oct. 19, 2018.

(51) Int. Cl. A23L 19/00; A23L 33/00; A23L 27/30; A23L 29/30; A23L 33/105

(52) U.S. Cl. CPC A23L 19/09; A23L 33/30; A23L 33/105; A23L 29/30; A23L 27/30

(57) ABSTRACT

Application is being made for a utility patent for the invention, “Tasty P”. This invention is a fresh fruit jelled desert (also servable as a smoothie) made from ripe papaya (paw paw) pulp. It is a natural whole food, wholesome and offers several health benefits.

### INFORMATION DISCLOSURE

1. Variations:

Tasty P may vary by fruit content and flavor, by the type of sweetener used in production and by packaging. The desert may be produced as basic using only papaya pulp, sweetener and flavors. Other fruit may be added to this basic mixture to create a fruit flavored combination. Banana and pineapple have been added to create two fruit based variations. A third fruit variation is mango and a fourth is “pinana” from a combination of banana and pineapple.

2. Sweeteners:

Splenda produces a light firm product that takes the least time to reach an acceptable degree of firmness in the refrigeration process. Compared to Stevia, it is the sweetener of choice for sweetness, cost and speed in setting during refrigeration.

Stevia as a sweetener also produces a light firm product but takes slightly longer than Splenda to harden. It is the sweetener of choice for guaranteed lowest possible glucose level but projects a somewhat higher cost of production than Splenda.

Cane (granulated) sugar takes the longest time to harden and produces a somewhat heavy tasting end product. The taste is slightly flat, flavors are subdued and not as readily distinguishable as is the case with Splenda and Stevia. It is the least expensive sweetener but comes with a slight reduction in the distinguishing tastiness of the product.

3. Packaging:

The fruit base of Tasty P is soft and malleable and will take on the shape of any container into which it is put. Consequently, it can be presented in any number of shapes and sizes.

4. Comparative Differences in Structure and Function:

Patentability search shows that no other papaya products have been made using identical components and process as Tasty P. Tasty P is a unique product in its ingredients and in the steps taken in processing these to produce the final product. 5. Making “Tasty P”:

The whole, fully ripe papaya is washed, peeled and deseeded (or deseeded then peeled—either way). The meat of the fruit is cut into cubes to fit into a blender and pureed into a pulp. The pulp is measured for adding sweeteners and flavors.

To each cup of pulp add:

| | |
|---|---|
| Sweetener | Splenda - 2 tablespoons, or |
| | Stevia 4 grams, or |
| | Granulated cane sugar - 2 Tablespoon |
| Flavors | 2 teaspoon fresh lemon juice |
| | 1 teaspoon vanilla extract |
| | 5 drops Angustura Bitters |

The above is the basic mixture.

Fruit Variations: To one cup of basic mixture add:

| | |
|---|---|
| Banana | 2 ounces pureed ripe banana |
| Pineapple | 2 ounces pureed pineapple pulp |

1. The whole papaya is a storehouse of nutrients with many health enhancing benefits. It is a rich source of vitamins C,B, A and E; folate, magnesium, copper, pantothenic acid, lutein, potassium and lycopene which is a powerful antioxidant. Papaya is known to help prevent asthma and cancer, reduce blood glucose levels in type 2 diabetes, promote healthy lipid levels and lower elevated blood pressure, reduce the risk and progression of age related macular degeneration, prevent constipation and promote a healthy digestive tract trough its high fiber content and enzyme papain, reduce chronic inflammation, support cognitive function, support bone health through its high content in vitamin K-7 and help ward off heart disease. Used topically, it enhances skin health and promotes wound healing; through its high vitamin A content it promotes hair growth and the growth of all cells.
Because of its conserving production process, “Tasty P” retains the full benefits of the whole papaya fruit. The thrust of this formulation is the creation of a food product that has a special benefit for diabetic and hypertensive populations. As a desert, it offers the advantage of a wholesome health promoting alternative in food choice in an area where food choice for these populations is limited by characteristic dietary restrictions. Tasty P is a healthy food choice for anyone but it provides a much needed opportunity in choice for persons who have diabetes, hypertension or both and must restrict foods with even moderate glucose and lipid levels.
